(19) United States
(12) Patent Application Publication
(10) Pub. No.: US 2026/0319622 A1
(43) Pub. Date: Oct. 15, 2026

(54) OPTICAL FINGER NAVIGATION DEVICE, CONTROL SYSTEM AND LIGHT CONTROLLER USING THE SAME

(71) Applicant: PIXART IMAGING INC., Hsin-Chu County (TW)

(72) Inventors: Chi-Yu WU, Hsin-Chu County (TW); Shao-Wei TSENG, Hsin-Chu County (TW); Yen-Min CHANG, Hsin-Chu County (TW); Chia-Fu KE, Hsin-Chu County (TW); Chung-Ting YANG, Hsin-Chu County (TW)

(21) Appl. No.: 19/360,996

(22) Filed: Oct. 17, 2025

Related U.S. Application Data
(60) Provisional application No. 63/785,645, filed on Apr. 9, 2025.

(51) Int. Cl. G06F 3/042; G06F 3/01; G06F 3/041

(52) U.S. Cl. CPC G06F 3/0421; G06F 3/017; G06F 3/0416

(57) ABSTRACT

There is provided an optical finger navigation device including a finger interface, a light source, a light sensor and a processor. The finger interface has a sensing surface for a finger to put thereon. The light source emits light toward the sensing surface. The light sensor receives reflected light from the sensing surface and outputs image frames. The processor detects, according to the image frames, a click event and a subsequent gesture of the finger while the finger remains in contact with the sensing surface to define a compound input gesture by the click event in combination with the subsequent gesture. There is further provided a control system and a light controller using the optical finger navigation device.

### CROSS REFERENCE TO RELATED APPLICATION

The present application claims the priority benefit of U.S. Provisional Application Serial Number U.S. 63/785,645, filed on Apr. 9, 2025, the disclosure of which is hereby incorporated by reference herein in its entirety.

### FIELD OF THE DISCLOSURE

This disclosure generally relates to an optical finger navigation device and, more particularly, to an optical finger navigation device capable of arranging different sensing areas corresponding to different applications and detecting compound input gestures, and a control system and a light controller using the same.

### BACKGROUND OF THE DISCLOSURE

The conventional control methods of electronic devices are implemented by using multiple physical buttons or knobs to respectively control different functions. The more functions are to be controlled, the more physical buttons or knobs are required. However, in the applications like wearable devices, portable devices, vehicle controls and industrial devices, there are generally not enough space for arranging the multiple physical buttons or knobs.

Although a capacitive touch panel or a resistive touch panel may be used to replace the physical buttons or knobs, the capacitive touch panel and the resistive touch panel have poor sensitivity to subtle motions and lower tolerance to environment factors such as moisture or dirt.

The information disclosed in this BACKGROUND is merely intended to increase understanding of the general background of the invention and should not be taken as an admission or in any way implied that the relevant information constitutes prior art that is already known to a person of ordinary skill in the art.

### SUMMARY

Accordingly, the present disclosure provides an optical finger navigation device capable of arranging different sensing areas corresponding to different applications and detecting compound input gestures formed by successive gestures on a timeline, and a control system and a light controller using the same.

The present disclosure further provides an optical finger navigation device capable of detecting a compound input gesture formed by a single click/tap or a double clicks/taps of a finger followed by a drag/swipe gesture and/or a stationary gesture of the finger and outputting a corresponding control signal, and a control system and a light controller using the same.

The present disclosure further provides an optical finger navigation device capable of detecting a compound input gesture formed by a single click/tap or a double clicks/taps of a finger in conjunction with a moving speed, a moving direction and/or a moving distance of the finger and outputting a corresponding control signal, and a control system and a light controller using the same.

The present disclosure further provides a control system that generates a combined gesture according to respective gestures of multiple optical finger navigations to accordingly output a control signal.

The present disclosure provides an optical finger navigation device including a finger interface, a light source, a light sensor and a processor. The finger interface includes a sensing surface configured for a finger to put thereon. The light source is configured to emit light toward the sensing surface. The light sensor is configured to receive reflected light from the sensing surface and output image frames. The processor is configured to detect a click event of the finger on the sensing surface, and a subsequent gesture of the finger while the finger remains in contact with the sensing surface, wherein the click event in combination with the subsequent gesture defines a compound input gesture.

The present disclosure further provides a control system including a first optical navigation device, a second optical finger navigation device and a processor. The first optical finger navigation device is configured to detect a first gesture. The second optical finger navigation device is configured to detect a second gesture and wirelessly coupled with the first optical finger navigation device to perform wireless communication. The processor is configured to form a combined gesture according to the first gesture detected by the first optical finger navigation device and the second gesture detected by the second optical finger navigation device, and output a control signal associated with the combined gesture.

The present disclosure further provides a light controller including an optical finger navigation device. The optical finger navigation device includes a processor and a control unit. The processor is configured to detect a click event or a compound input gesture of a finger on a sensing surface. The control unit is configured to control at least one of turning on/off and intensity of at least one lighting device according to the control signal.

### BRIEF DESCRIPTION OF DRAWINGS

Other objects, advantages, and novel features of the present disclosure will become more apparent from the following detailed description when taken in conjunction with the accompanying drawings.

FIG. 1 is a schematic diagram of an optical finger navigation according to a first embodiment of the present disclosure.

FIG. 2A is a schematic diagram of a single-click gesture detected by an optical finger navigation according to one embodiment of the present disclosure.

FIG. 2B is a schematic diagram of a double-click gesture detected by an optical finger navigation according to one embodiment of the present disclosure.

FIGS. 2C to 2J are schematic diagrams of compound input gestures detected by an optical finger navigation according to some embodiments of the present disclosure.

FIG. 3 is a schematic diagram of a control system including two optical finger navigations according to a second embodiment of the present disclosure.

FIGS. 4A to 4C are operational schematic diagrams of a light controller adopting an optical finger navigation of FIG. 1 according to one embodiment of the present disclosure.

FIG. 5 is a schematic diagram of arranging an optical finger navigation of the present disclosure inside a vehicle.

### DETAILED DESCRIPTION OF THE DISCLOSURE

It should be noted that, wherever possible, the same reference numbers will be used throughout the drawings to refer to the same or like parts.

One objective of the present disclosure is to provide an optical finger navigation device that outputs a control signal corresponding to a click event or a tapping action (e.g., a single click/tap, multiple clicks/taps) and a compound input gesture to perform various controls, and a control system and a light controller using the optical finger navigation device. In the present disclosure, the various controls are implemented by a single device thereby obtaining a simple, low cost and instinctive human machine interface device. In addition, another objective of the present disclosure is to provide a control system that uses wirelessly coupled multiple optical finger navigation devices to generate a combined gesture.

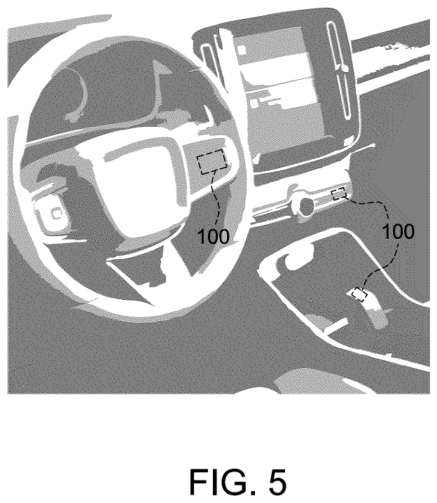

The optical finger navigation device of the present disclosure may be arranged on different devices according to different applications, e.g., arranged on a vehicle steering wheel, a vehicle gearshift lever, a vehicle console (e.g., referring to FIG. 5), a portable device, a wearable device, a notebook computer, a tablet computer, a desktop computer, a workstation or any electronic device that is controlled through a button, a knob, a resistive touchpad or a capacitive touchpad.

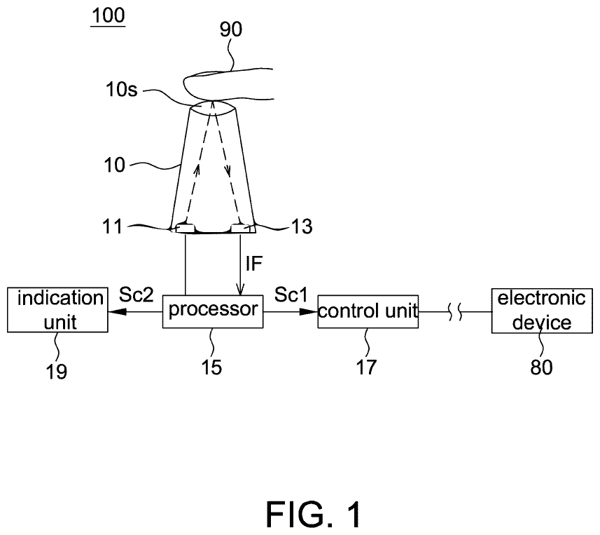

Please refer to FIG. 1, it is a schematic diagram of an optical finger navigation device/module (or abbreviated as optical finger navigation, OFN) 100 according to a first embodiment of the present disclosure. The optical finger navigation 100 includes a finger interface 10, a light source 11, a light sensor 13, a processor 15, a control unit 17 and an indication unit 19. In one aspect, the finger interface 10, the light source 11, the light sensor 13, the processor 15 and the control unit 17 are accommodated in the same package, which has electrical contacts for electrically coupling to the electronic device/element to be controlled, e.g., coupling the control unit 17 to the electronic device 80, which has a type determined according to the different applications mentioned above. In one aspect, the control unit 17 is included in the processor 15, and a function of thereof is considered to be performed by the processor 15. The indication unit 19 may be arranged inside the optical finger navigation 100, or arranged outside the optical finger navigation 100 and electrically coupled to the processor 15 of the optical finger navigation 100. The indication unit 19 is used to reflect the detecting result of the optical finger navigation 100, e.g., reflecting by light emitting diode(s), vibrator(s), speaker(s), a liquid crystal display, but not limited to. That is, the electronic device 80 is controlled by the optical finger navigation 100, and the indication unit 19 is used to show a control status of the optical finger navigation 100.

In the present disclosure, the optical finger navigation 100 is not limited to must include the indication unit 19. The control unit 17 is wired or wirelessly coupled to the electronic device 80 for corresponding controls.

The finger interface 10 is made of transparent material (e.g., by injection molding or dispensing, but not limited to). The finger interface 10 includes a sensing surface 10s for a finger 90 to put thereon. The sensing surface 10s is a plane surface or a curved surface, and has an area larger than, smaller than or substantially identical to a finger area, which is determined according to statistical data or learning result of an artificial intelligent (AI) algorithm before shipment, according to different applications. The finger interface 10 is not limited to have the shape shown in FIG. 1.

For example in the applications like vehicle devices (e.g., referring to FIG. 5), portable devices and wearable devices, an area of the sensing surface 10s is smaller than or substantially identical to the finger area; whereas in the applications like notebook computers, desktop computers, tablet computers and workstations, an area of the sensing surface 10s is larger than the finger area. That is, the area of the sensing surface 10s is determined according to a space that the electronic device 80 provides.

The light source 11 is a light emitting diode (LED) or a laser diode (LD), and is used to emit recognizable light, e.g., infrared light, but not limited to, toward the sensing surface 10s. If there is no finger 90 on the sensing surface 10s, emission light of the light source 11 penetrates out from the sensing surface 10s. If there is a finger 90 on/touching the sensing surface 10s, the emission light of the light source 11 is reflected by the finger 90.

The light sensor 13 is, for example, a complementary metal-oxide-semiconductor (CMOS) image sensor, a charge couple device (CCD) image sensor or a single photon avalanche diode (SPAD) image sensor. The light sensor 13 uses a predetermined operation frequency (or called frame rate) to receive reflected light from the sensing surface 10s and outputs image frames IF. It should be mentioned that although FIG. 1 shows that the light source 11 and the light sensor 13 are arranged inside the finger interface 10, it is only intended to illustrate but not to limit the present disclosure. In another aspect, at least one of the light source 11 and the light sensor 13 is arranged outside of the finger interface 10.

The processor 15 is, for example, a micro controller unit (MCU) or a graphics processor unit (GPU). The processor 15 is used to control the light source 11 to emit light, to control the light sensor 13 to acquire image frames IF, and to detect a click event (e.g., including a single-click and a multiple-click) of the finger 90 on the sensing surface 10s and a subsequent gesture of the finger 90 while the finger 90 remains in contact with (e.g., putting on and without leaving) the sensing surface 10s after the click event to form a compound input gesture, examples being given below. The processor 15 performs functions thereof using software, hardware and/or firmware.

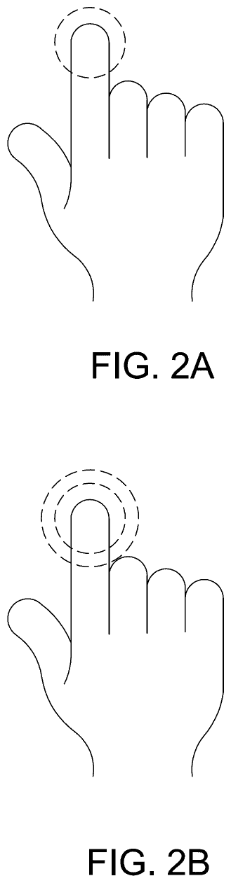

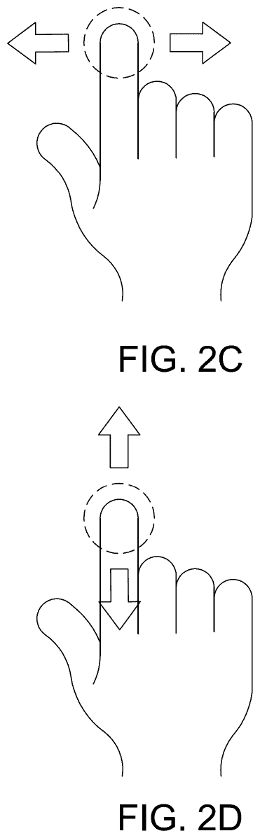

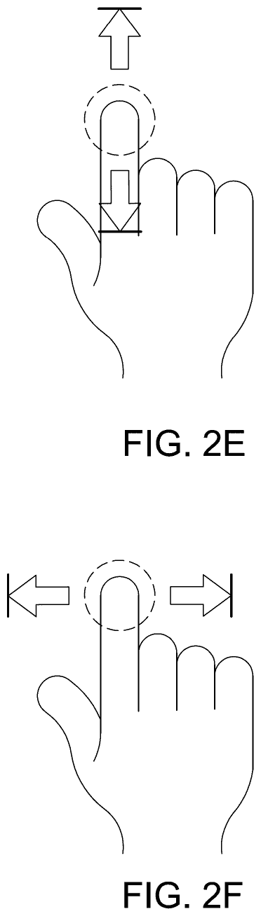

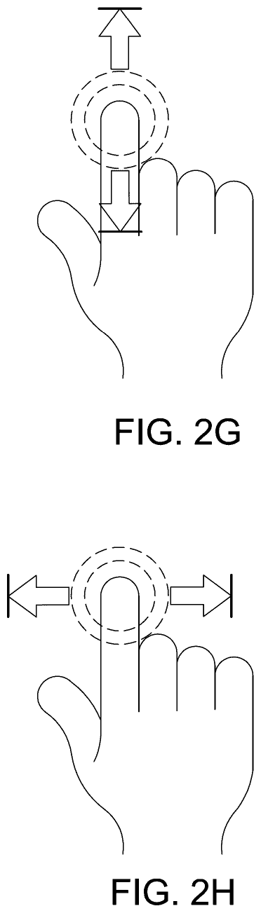

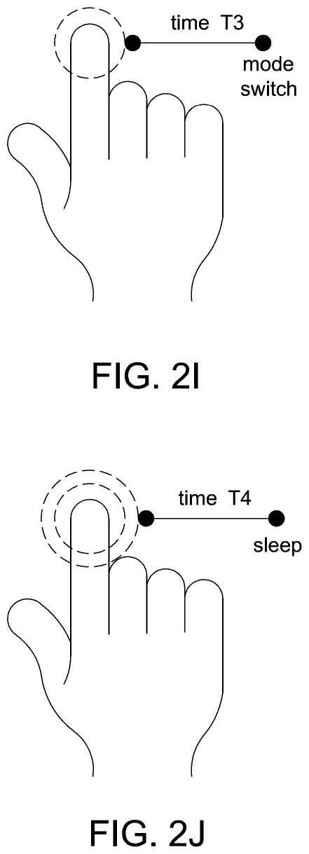

FIG. 2A shows a single-click operation of the finger 90, e.g., the single-click being indicated by one circle of dotted line for illustration purposes; and FIG. 2B shows a double-click operation of the finger 90, e.g., the double-click being indicated by two circles of dotted line for illustration purposes. Said double-click operation is referred to an operation interval between two clicks/taps being shorter than a predetermined time interval. When the operation interval between the two clicks/taps is larger than the predetermined time interval, the processor 15 identifies two individual single-click operations. One method of identifying the single-click and the double-click may be referred to U.S. patent application Ser. No. 13/613,707, entitled “CLICK EVENT DETECTION DEVICE” filed on Sep. 13, 2012, assigned to the same assignee of the present application, and the full disclosure of which is incorporated herein by reference, but the present disclosure is not limited thereto.

In one aspect, the single-click operation (e.g., the finger 90 being taken off the sensing surface 10s within a predetermined time interval after a touch) is used to wake up (e.g., using the control signal Sc1) a system sleep state of the electronic device 80, but not limited thereto; and the double-click operation (e.g., the finger 90 being taken off the sensing surface 10s within a predetermined time interval after a second touch) is used to wake up a system sleep state of the electronic device 80 and to cause the electronic device 80 to perform operations or states executed before the system sleep state is entered, but not limited thereto.

FIGS. 2C and 2D respectively show a compound input gesture formed by a single-click+a drag/swipe gesture of the finger 90. When the processor 15 identifies that the finger 90 does not leave the sensing surface 10s after the single-click and then moves toward a predetermined direction (e.g., upward, downward, leftward or rightward, but not limited to) without leaving the sensing surface 10s, a control signal Sc1 different from the simple single-click (e.g., FIG. 2A) is triggered, e.g., including triggering ON/OFF functions and controlled target selection, but not limited thereto. In addition, a dragging distance and a dragging speed may be arranged to trigger different control signals Sc1 as long as the processor 15 is previously recorded with control signals Sc1 (e.g., indicated by multiple digital codes) corresponding to different dragging directions, dragging distances and/or dragging speeds. In one aspect, the drag/swipe gesture subsequent to the single-click operation preferably starts within a predetermined time interval after the finger 90 puts on the sensing surface 10s to prevent the processor 15 from identifying a different subsequent gesture, e.g., showing in FIG. 2I.

FIGS. 2E and 2F respectively show a compound input gesture formed by a single-click+a drag/swipe gesture+a stationary gesture of the finger 90. When the processor 15 identifies that the finger 90 does not leave the sensing surface 10s after the single-click and holds on the sensing surface 10s for more than a first predetermined time interval after moving toward a predetermined direction without leaving the sensing surface 10s, a control signal Sc1 different from FIGS. 2A, 2C and 2D is triggered, e.g., including triggering intensity adjustment functions of controlled target and display adjustment functions, but not limited thereto. Similarly, a dragging distance (e.g., holding position from the click position) and a dragging speed (e.g., holding time point from the click time point) may be arranged to trigger different control signals Sc1 as long as the processor 15 is previously recorded with control signals Sc1 corresponding to different dragging directions, dragging distances and/or dragging speeds. Similarly, the drag/swipe gesture subsequent to the single-click operation preferably starts within a predetermined time interval after the finger 90 puts on the sensing surface 10s to prevent the processor 15 from identifying a different subsequent gesture, e.g., showing in FIG. 2I.

FIGS. 2G and 2H respectively show a compound input gesture formed by a double-click+a drag/swipe gesture+a stationary gesture of the finger 90. When the processor 15 identifies that the finger 90 does not leave the sensing surface 10s after the double-click and holds on the sensing surface 10s for more than a second predetermined time interval (e.g., identical to or different from the first predetermined time interval) after moving toward a predetermined direction without leaving the sensing surface 10s, a control signal Sc1 different from FIG. 2B is triggered, e.g., including triggering intensity adjustment functions for all controlled targets and display adjustment functions, but not limited thereto. Similarly, a dragging distance (e.g., holding position from the click position) and a dragging speed (e.g., holding time point from the click time point) may be arranged to trigger different control signals Sc1 as long as the processor 15 is previously recorded with control signals Sc1 corresponding to different dragging directions, dragging distances and/or dragging speeds. Similarly, the drag/swipe gesture subsequent to the double-click operation preferably starts within a predetermined time interval after the finger 90 puts on the sensing surface 10s for the second time to prevent the processor 15 from identifying a different subsequent gesture, e.g., showing in FIG. 2J.

Similarly to FIGS. 2C and 2D, the finger 90 may perform a double-click+a drag/swipe gesture without performing the stationary gesture (e.g., the finger 90 taken off the sensing surface 10s within the second predetermined time interval after dragging) to trigger a different control signal Sc1, e.g., triggering ON/OFF functions for all controlled targets, but not limited thereto.

FIG. 2I shows a compound input gesture formed by a single-click+a stationary gesture of the finger 90. When the processor 15 identifies that the finger 90 does not leave the sensing surface 10s after the single-click and holds on the sensing surface 10s for more than a third predetermined time interval T3 (e.g., identical to or different from the first predetermined time interval), a control signal Sc1 different from FIG. 2A is triggered, e.g., including triggering the mode switching or showing menu on a screen, but not limited thereto.

FIG. 2J shows a compound input gesture formed by a double-click+a stationary gesture of the finger 90. When the processor 15 identifies that the finger 90 does not leave the sensing surface 10s after the double-click and holds on the sensing surface 10s for more than a fourth predetermined time interval T4 (e.g., identical to or different from the second predetermined time interval), a control signal Sc1 different from FIG. 2B is triggered, e.g., including triggering system sleeping or user ID switching, but not limited thereto.

That is, in the first embodiment, the subsequent gesture of a finger 90 while the finger 90 remains in contact with the sensing surface 10s includes at least one of a stationary gesture holding for more than a predetermined time interval and/or a drag/swipe gesture such as a dragging direction, a dragging distance and/or a dragging speed, but not limited thereto. The subsequent gesture may further include a circle drawing gesture in a clockwise direction and a counter-clockwise direction. In addition, the dragging direction may be other directions and is not limited to the upward, the downward, the leftward and the rightward mentioned herein as long as the processor 15 is recognizable.

The control unit 17 correspondingly controls the electronic device 80 according to a control signal Sc1 associated with the single-click (e.g., FIG. 2A), the multiple-click (e.g., FIG. 2B) and the compound input gesture (e.g., FIGS. 2C to 2J) received from the processor 15. The indication unit 19 indicates corresponding states, e.g., by lamp(s), a display screen, sound(s) or vibration(s), but not limited to, according to a control signal Sc2 associated with the single-click, the multiple-click and the compound input gesture received from the processor 15. That is, the compound input gesture in the present disclosure is defined by a click event of a finger 90 in combination with a subsequent gesture of the finger 90.

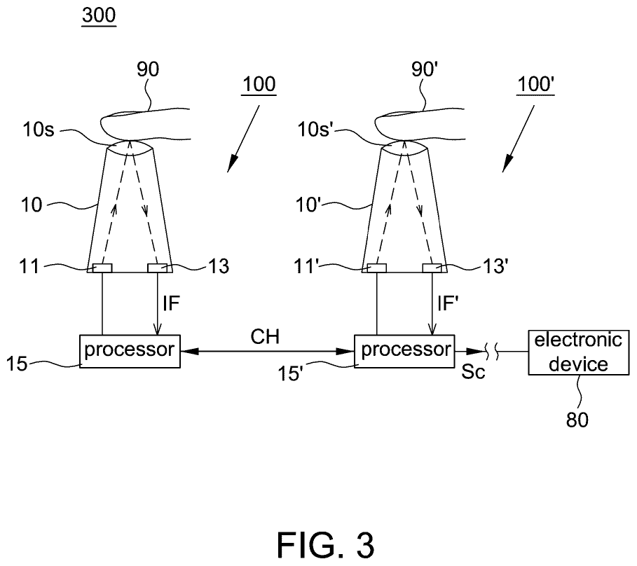

Please refer to FIG. 3, it is a schematic diagram of a control system 300 according to a second embodiment of the present disclosure. The control system 300 includes a first optical finger navigation 100 and a second optical finger navigation 100′ (e.g., identical to the optical finger navigation 100 in FIG. 1). The second optical finger navigation 100′ is wirelessly coupled (e.g., shown as CH, such as a Bluetooth channel or a Wi-Fi channel) with the first optical finger navigation 100 to perform wireless communication. The first optical finger navigation 100 and the second optical finger navigation 100′ are previously paired such that the communication channel CH is automatically constructed when a distance therebetween is close enough, e.g., identified by a signal strength indicator, RSSI, but not limited to use the RSSI. The method of identifying the distance using the RSSI is known to the art and not a main objective of the present disclosure, and thus details thereof are not described herein.

The first optical finger navigation 100 and the second optical finger navigation 100′ are respectively arranged on two of the above mentioned applications such as the vehicle devices, portable devices, wearable devices and various computers. In one aspect, the first optical finger navigation 100 and the second optical finger navigation 100′ are respectively arranged on a wearable device (e.g., a ring or an arm band, but not limited to) or a portable device (e.g., a smartphone, but not limited to). In another aspect, one of the first optical finger navigation 100 and the second optical finger navigation 100′ is arranged on a wearable device and the other one of the first optical finger navigation 100 and the second optical finger navigation 100′ is arranged on a vehicle steering wheel, a vehicle gearshift lever, a vehicle console, a portable device, a notebook computer, a tablet computer, a desktop computer or a workstation.

The processor 15 of the first optical finger navigation 100 is used to identify a first gesture according to image frames IF acquired by the light sensor 13, and the first gesture includes a click event such as a single-click (e.g., referring to FIG. 2A), a multiple-click (e.g., referring to FIG. 2B) or a first compound input gesture of a finger 90 on a sensing surface 10s of the first optical finger navigation 100. As mentioned above, the first compound input gesture includes the click event of the finger 90 and a first subsequent gesture (e.g., referring to FIGS. 2C to 2J) of the finger 90 while the finger 90 remains in contact with (e.g., putting on and without leaving) the sensing surface 10s of the first optical finger navigation 100 after the click event of the finger 90.

The processor 15′ of the second optical finger navigation 100′ is used to identify a second gesture according to image frames IF′ acquired by the light sensor 13′, and the second gesture includes a click event such as a single-click (e.g., referring to FIG. 2A), a multiple-click (e.g., referring to FIG. 2B) or a second compound input gesture of a finger 90′ (different from the finger 90) on a sensing surface 10s′ of the second optical finger navigation 100′. As mentioned above, the second compound input gesture includes the click event of the finger 90′ and a second subsequent gesture (e.g., referring to FIGS. 2C to 2J) of the finger 90′ while the finger 90′ remains in contact with (e.g., putting on and without leaving) the sensing surface 10s′ of the second optical finger navigation 100′ after the click event of the finger 90′.

The processor 15 or 15′ (previously arranged) generates a combined gesture according to the first gesture on the first optical finger navigation 100 and the second gesture on the second optical finger navigation 100′, and generates a control signal Sc associated with the combined gesture to perform corresponding controls on the electronic device 80. In the second embodiment, the electronic device 80 is controlled by the processor 15 or 15′ (e.g., 15′ shown in FIG. 3 as an example), and the processor 15 transmits a signal associated with the first gesture to the processor 15′ via the communication channel CH. The processor 15′ is previously recorded with control signals Sc corresponding to different combined gestures.

In one aspect, the combined gesture is used as an unlock gesture (like a password), a sleep ending gesture or an activation gesture of the electronic device 80 according to different applications. In addition, when only one of the processors 15 and 15′ detects a finger, the combined gesture or the control signal Sc is not generated, i.e. unable to control the electronic device 80 using the combined gesture.

In one aspect, when the electronic device 80 is unlocked/activated by receiving the control signal Sc, the processor 15′ (e.g., arranged on the electronic device 80) then controls the electronic device 80 using the method mentioned in the first embodiment (e.g., shown in FIG. 2A to 2J), and thus details thereof are not repeated herein. In one aspect, when the electronic device 80 is unlocked/activated by receiving the control signal Sc, the processor 15 (e.g., not arranged on the electronic device 80) is not used to control the electronic device 80.

In another aspect, the combined gesture of the first optical finger navigation 100 and the second optical finger navigation 100′ is used as a device switching gesture in a smart home. For example, after a first electronic device is unlocked/activated by a first combined gesture, a second combined gesture detected by the first optical finger navigation 100 and the second optical finger navigation 100′ is used to lock/deactivate the first electronic device and switch to unlock/activate another electronic device, e.g., determined according to a type of the combined gesture. In this way, the controlled device switching is performed by the combined gesture detected by the first optical finger navigation 100 and the second optical finger navigation 100′, and the compound input gesture of a single optical finger navigation (100 or 100′, previously determined) is used to control the activated electronic device. The method of controlling an electronic device by a compound input gesture is similar to FIGS. 2C to 2J, and thus details thereof are not repeated again.

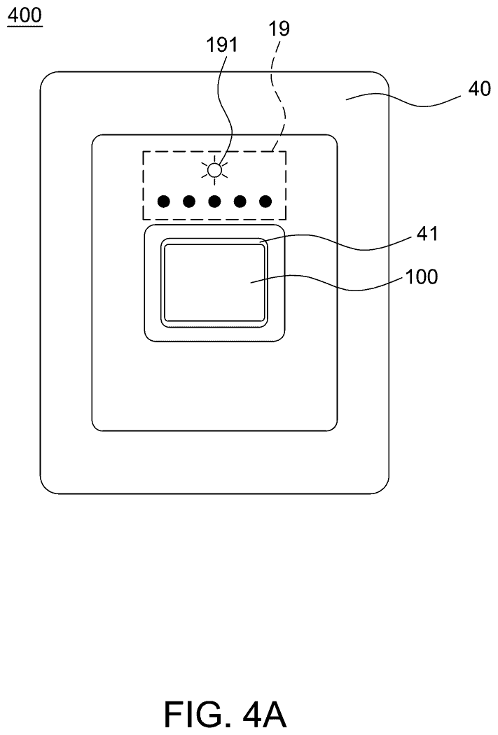

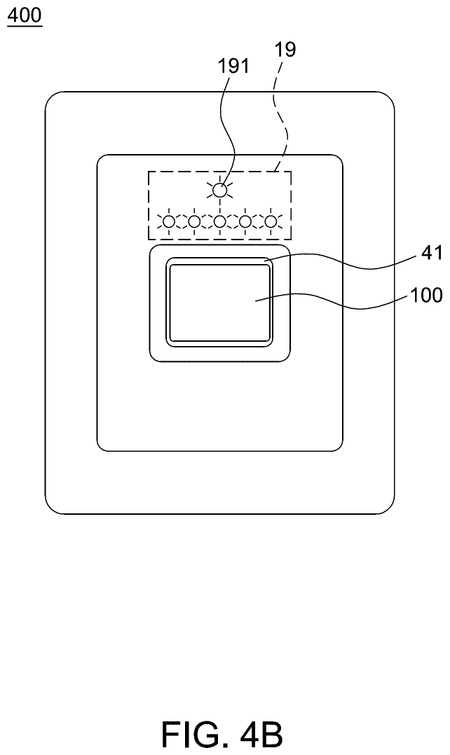

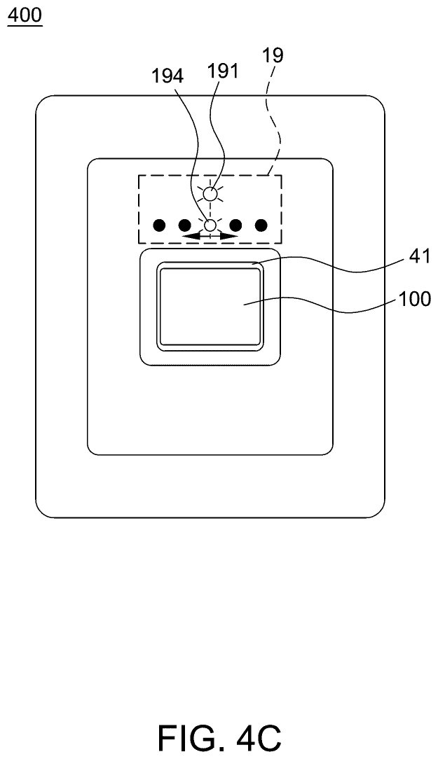

Please refer to FIGS. 4A to 4C, they are operational schematic diagrams of a light controller 400 using the optical finger navigation 100 according to one embodiment of the present disclosure, wherein the indication unit 19 is described by having multiple lamps (e.g., LED or LD), but the present disclosure is not limited to lamps. In this embodiment, the indication unit 19 is electrically coupled to the OFN 100.

The light controller 400 includes a housing 40 for arranging the optical finger navigation 100 (e.g., referring to FIG. 1) and the indication unit 19 thereon. In one aspect, a groove or a surface having a different material from that of a sensing surface 10s of the optical finger navigation 100 is arranged surrounding the sensing surface 10s to allow a user to be aware of a range of the sensing surface 10s during operation.

As mentioned above, the optical finger navigation 100 includes a processor 15 and a control unit 17. In this embodiment, the control unit 17 is wired or wirelessly (e.g., including a wireless communication chip) coupled to the electronic device 80, i.e. including at least one lighting device such as fluorescent light source, LED light source, Neon light or light bulbs. In one aspect, the at least one lighting device is able to illuminate at different intensity and different color temperatures.

The processor 15 is used to detect a click event (e.g., a single-click, a multiple-click) or a compound input gesture of a finger 90 on the sensing surface 10s, and generates the control signals Sc1 and Sc2, which are described in the first embodiment and thus details thereof are not repeated again.

The control unit 17 is used to control at least one of turning on/off, intensity, color temperatures and work modes of the least one lighting device according to the control signal Sc1.

For example, when the processor 15 of the optical finger navigation 100 detects a single-click operation shown in FIG. 2A, a control signal Sc1 is generated and the control unit 17 is used to terminate a power saving mode of a smart system (e.g., for smart controlling the at least one lighting device and other home appliances) according to the control signal Sc1. Meanwhile, an activation lamp 191 shown in FIG. 4A is lighted up (or illuminating in a different color) to indicate that the power saving mode is ended, e.g., controlled by the control signal Sc2.

For example, when the processor 15 of the optical finger navigation 100 detects a double-click operation shown in FIG. 2B, a control signal Sc1 is generated and the control unit 17 is used to light up all lighting devices according to the control signal Sc1. Meanwhile, the activation lamp 191 and five lamps below the activation lamp 191 are lighted up (or illuminating in a different color) as shown in FIG. 4B to indicate that all lighting devices are turned on, e.g., controlled by the control signal Sc2. It should be mentioned that a number of the lighting devices are not limited to five.

For example, when the processor 15 of the optical finger navigation 100 detects a single-click+a drag gesture as shown in FIG. 2C, a control signal Sc1 is generated and the control unit 17 is used to light up a different lighting device according to the control signal Sc1 triggered by a dragging direction. Meanwhile, the lighted lamp (e.g., 194 shown in FIG. 4C) on the indication unit 19 changes, e.g., controlled by the control signal Sc2, according to a moving direction (e.g., left or right direction) and a moving distance of the finger 90.

For example, when the processor 15 of the optical finger navigation 100 detects a single-click+a drag gesture as shown in FIG. 2D, a control signal Sc1 is generated and the control unit 17 is used to turn on one lighting device (e.g., the finger 90 moving upward) and turn off the one lighting device (e.g., the finger 90 moving downward) according to the control signal Sc1 triggered by the dragging direction. Meanwhile, a lamp (e.g., 194 shown in FIG. 4C) on the indication unit 19 is turned on or turned off according to the control signal Sc2 triggered by the moving direction (e.g., up or down direction) of the finger 90 to indicate that the one lighting device is lighted up or not.

For example, when the processor 15 of the optical finger navigation 100 detects a single-click+a drag gesture+a stationary gesture as shown in FIG. 2E, a control signal Sc1 is generated and the control unit 17 increases (e.g., the finger 90 moving upward) or decreases (e.g., the finger 90 moving downward) intensity of the currently lighted lighting device(s) according to the control signal Sc1. Meanwhile, at least one lamp on the indication unit 19 changes intensity or color to indicate different intensity of the currently lighted lighting device(s) according to the moving direction (e.g., up or down direction) of the finger 90 according to the control signal Sc2.

For example, when the processor 15 of the optical finger navigation 100 detects a single-click+a drag gesture+a stationary gesture as shown in FIG. 2F, a control signal Sc1 is generated and the control unit 17 increases (e.g., the finger 90 moving rightward) or decreases (e.g., the finger 90 moving leftward) a color temperature of the currently lighted lighting device(s) according to the control signal Sc1. Meanwhile, at least one lamp on the indication unit 19 changes intensity or color to indicate different color temperatures of the currently lighted lighting device(s) according to the moving direction (e.g., left or right direction) of the finger 90 according to the control signal Sc2.

For example, when the processor 15 of the optical finger navigation 100 detects a double-click+a drag gesture+a stationary gesture as shown in FIG. 2G, a control signal Sc1 is generated and the control unit 17 increases (e.g., the finger 90 moving upward and holding for more than a predetermined time interval) or decreases (e.g., the finger 90 moving downward and holding for more than a predetermined time interval) intensity of all lighting devices according to the control signal Sc1. The increment and decrement of the intensity may be determined according to the moving distance and/or the moving speed of the finger 90. Meanwhile, all lamps (e.g., not including 191, but not limited to) on the indication unit 19 change intensity or color to indicate different intensity of the all lighting devices according to the moving direction (e.g., up or down direction) of the finger 90 according to the control signal Sc2.

For example, when the processor 15 of the optical finger navigation 100 detects a double-click+a drag gesture+a stationary gesture as shown in FIG. 2H, a control signal Sc1 is generated and the control unit 17 increases (e.g., the finger 90 moving rightward and holding for more than a predetermined time interval) or decreases (e.g., the finger 90 moving leftward and holding for more than a predetermined time interval) color temperatures of all lighting devices according to the control signal Sc1. The increment and decrement of the color temperatures may be determined according to the moving distance and/or the moving speed of the finger 90. Meanwhile, all lamps (e.g., not including 191, but not limited to) on the indication unit 19 change intensity or color to indicate different color temperatures of the all lighting devices according to the moving direction (e.g., left or right direction) of the finger 90 according to the control signal Sc2.

For example, when the processor 15 of the optical finger navigation 100 detects a single-click+a stationary gesture as shown in FIG. 2I, a control signal Sc1 is generated and the control unit 17 switches a work mode of all lighting devices according to the control signal Sc1, e.g., a first mode including 100% intensity+5500K color temperature, a second mode including 60% intensity+4000K color temperature, and a third mode 20% intensity+2700K color temperature, but not limited to three modes. Meanwhile, all lamps (including or not including 191) on the indication unit 19 change intensity or color correspondingly with a predetermined pattern to indicate different work modes, e.g., controlled by the control signal Sc2.

For example, when the processor 15 of the optical finger navigation 100 detects a double-click+a stationary gesture as shown in FIG. 2J, a control signal Sc1 is generated and the control unit 17 turns off all lighting devices or controls a smart system to sleep according to the control signal Sc1. Meanwhile, all lamps (including or not including 191) on the indication unit 19 are all turned off or lighted with a different color to indicate the control status, e.g., controlled by the control signal Sc2.

It is appreciated that when a color temperature of the at least one lighting device is not adjustable, the optical finger navigation 100 is not arranged with the corresponding operation gestures.

In a word, in the embodiment of the light controller 400, the control unit 17 is used to control at least one of turning ON/OFF, illuminating intensity, illuminating color temperature and work mode of at least one lighting device according to the control signal Sc1. The indication unit 19 is used to light up change color of lamp(s) corresponding to the turning ON/OFF, illuminating intensity, illuminating color temperature and work mode of the at least one lighting device according to the control signal Sc2. The control signals Sc1 and Sc2 are identical to or different from each other.

It should be mentioned that lamps of the indication unit 19 of the light controller 400 of the present disclosure are not limited to illuminate constantly but are controlled to flick at a predetermined frequency to indicate a user is operating the optical finger navigation 10 and allow the user to know a control status.

In another aspect, the indication unit 19 is a liquid crystal display, which shows corresponding information by words and/or graphs corresponding to the operations in FIGS. 2A to 2J mentioned above.

In another aspect, the lighting devices are replaced by speakers, and the optical finger navigation 100 is used to control target switching, turning ON/OFF, volume and directionality of different speakers.

In another aspect, the lighting devices are replaced by cameras, and the optical finger navigation 100 is used to control target switching, turning ON/OFF, frame rate, shutter and power saving mode of different cameras.

It should be mentioned that all values, the shape of components, the number of and arranged position of components mentioned in the present disclosure are only intended to illustrate but not to limit the present disclosure.

The optical finger navigation of the present disclosure has a practical application in realizing a simple, low cost and instinctive human machine interface device by using a single device to implement various controls.

It should be mentioned that controls on the electronic device 80 corresponding to various gestures (including the single-click, the multiple-click, the compound input gesture and the combined gesture) are only intended to illustrate but not to limit the present disclosure. The controls on the electronic device 80 corresponding to various gestures are different corresponding to actual applications, and are not limited to those mentioned in the present disclosure.

It should be mentioned that although the multiple clicks/taps in the present disclosure is described by double clicks/tabs, it is not to limit the present disclosure. The multiple clicks/taps may be a number of clicks/tabs more than two clicks/tabs as long as a time interval between every two clicks/tabs of the multiple clicks/taps is shorter than a predetermined time interval.

As mentioned above, because the conventional human machine interface device adopts multiple physical buttons or knobs, a large space is required to arrange the multiple physical buttons or knobs such that it is not suitable to be applied to some applications that are not able to provide enough allocation space, e.g., wearable devices or portable devices. Accordingly, the present disclosure further provides an optical finger navigation using a single device to implement various controls (e.g., FIG. 1) and a control system (e.g., FIG. 3) and a light controller (e.g., FIGS. 4A-4C) using the optical finger navigation that outputs a corresponding control signal according to a single-click, a double-click or a compound input gesture thereon to perform various controls of an electronic device. Said various controls include different functions of a single electronic device or different electronic devices.

Although the disclosure has been explained in relation to its preferred embodiment, it is not used to limit the disclosure. It is to be understood that many other possible modifications and variations can be made by those skilled in the art without departing from the spirit and scope of the disclosure as hereinafter claimed.

1. An optical finger navigation device, comprising:
a finger interface, comprising a sensing surface configured for a finger to put thereon;
a light source, configured to emit light toward the sensing surface;
a light sensor, configured to receive reflected light from the sensing surface and output image frames; and
a processor, configured to detect a click event of the finger on the sensing surface, and a subsequent gesture of the finger while the finger remains in contact with the sensing surface, wherein the click event in combination with the subsequent gesture defines a compound input gesture.

2. The optical finger navigation device as claimed in claim 1, wherein the subsequent gesture comprises a stationary gesture holding for more than a predetermined time interval.

3. The optical finger navigation device as claimed in claim 1, wherein the subsequent gesture comprises at least one of a dragging direction, a dragging distance and a dragging speed.

4. The optical finger navigation device as claimed in claim 1, further comprising:
a control unit, configured to receive a control signal associated with the compound input gesture to accordingly control an electronic device.

5. The optical finger navigation device as claimed in claim 1, wherein
the optical finger navigation device is configured to be arranged on a vehicle steering wheel, a vehicle gearshift lever, a vehicle console, a portable device or a wearable device, and
an area of the sensing surface is smaller than a finger surface.

6. A control system, comprising:
a first optical finger navigation device, configured to detect a first gesture;
a second optical finger navigation device, configured to detect a second gesture and wirelessly coupled with the first optical finger navigation device to perform wireless communication; and
a processor, configured to
form a combined gesture according to the first gesture detected by the first optical finger navigation device and the second gesture detected by the second optical finger navigation device, and
output a control signal associated with the combined gesture.

7. The control system as claimed in claim 6, wherein the processor is arranged inside the first optical finger navigation device or the second optical finger navigation device.

8. The control system as claimed in claim 6, wherein the combined gesture is configured as an unlock gesture, a sleep ending gesture, a device switching gesture or an activation gesture.

9. The control system as claimed in claim 6, wherein the first optical finger navigation device and the second optical finger navigation device are respectively arranged on a wearable device.

10. The control system as claimed in claim 6, wherein
one of the first optical finger navigation device and the second optical finger navigation device is arranged on a wearable device, and
the other one of the first optical finger navigation device and the second optical finger navigation device is arranged on a vehicle steering wheel, a vehicle gearshift lever, a vehicle console, a portable device or a computer device.

11. The control system as claimed in claim 6, wherein
the first gesture comprises a click event or a first compound input gesture of a finger on a sensing surface of the first optical finger navigation device, and the first compound input gesture comprises the click event of the finger and a first subsequent gesture of the finger while the finger remains in contact with the sensing surface of the first optical finger navigation device, and
the second gesture comprises another click event or a second compound input gesture of another finger on a sensing surface of the second optical finger navigation device, and the second compound input gesture comprises the another click event of the another finger and a second subsequent gesture of the another finger while the another finger remains in contact with the sensing surface of the second optical finger navigation device.

12. The control system as claimed in claim 11, wherein the first subsequent gesture and the second subsequent gesture respectively comprises a stationary gesture holding for more than a predetermined time interval.

13. The control system as claimed in claim 11, wherein the first subsequent gesture and the second subsequent gesture respectively comprises at least one of a dragging direction, a dragging distance and a dragging speed.

14. A light controller, comprising:
an optical finger navigation device, comprising:
a processor, configured to detect a click event or a compound input gesture of a finger on a sensing surface; and
a control unit, configured to control at least one of turning on/off and intensity of at least one lighting device according to the control signal.

15. The light controller as claimed in claim 14, wherein the control unit is further configured to control at least one of a color temperature and a work mode of the at least one lighting device according to the control signal.

16. The light controller as claimed in claim 15, further comprising:
indication lamps, configured to light up lamps corresponding to the turning on/off, the intensity, the color temperature and the work mode of the at least one lighting device according to the control signal.

17. The light controller as claimed in claim 14, wherein the compound input gesture comprises the click event of the finger on the sensing surface and a subsequent gesture of the finger while the finger remains in contact with the sensing surface.

18. The light controller as claimed in claim 17, wherein the subsequent gesture comprises at least one of a stationary gesture holding for more than a predetermined time interval, a dragging direction, a dragging distance and a dragging speed.

19. The light controller as claimed in claim 14, wherein the control unit is further configured to terminate a power saving mode of a smart system according to the control signal.

20. The light controller as claimed in claim 14, wherein the control unit is wired or wirelessly coupled to the at least one lighting device.
